(19) United States
(12) Patent Application Publication
(10) Pub. No.: US 2025/0375885 A1
(43) Pub. Date: Dec. 11, 2025

(54) METHOD FOR SCHEDULING PICKING ROBOTS, ELECTRONIC DEVICE AND STORAGE MEDIUM

(71) Applicant: Beijing Youzhuju Network Technology Co., Ltd., Beijing (CN)

(72) Inventors: Linge ZHANG, Beijing (CN); Yin YIN, Beijing (CN)

(21) Appl. No.: 19/038,424

(22) Filed: Jan. 27, 2025

(30) Foreign Application Priority Data
Jun. 5, 2024 (CN) 202410726004.1

(51) Int. Cl. B25J 9/16

(52) U.S. Cl. CPC B25J 9/1687; B25J 9/162; B25J 9/1682

(57) ABSTRACT

Embodiments of the present disclosure provide a method for scheduling picking robots, an electronic device and a storage medium. The method includes: sorting, in response to receiving multiple picking tasks, the multiple picking tasks based on task association information corresponding to the picking tasks to obtain a task sorting result, the task association information including at least one of total quantity of items of items to be picked corresponding to the picking tasks, packing information, or category information; and scheduling a picking robot to execute the picking tasks according to a working stage of the picking robot and the task sorting result, the working stage including at least one of a picking stage, a packing stage, a replenishment stage, an idle stage, or a maintenance stage.

### CROSS-REFERENCE TO RELATED APPLICATION

This application claims the priority to and benefits of the Chinese Patent Application, No. 202410726004.1, which was filed on Jun. 5, 2024. The aforementioned patent application is hereby incorporated by reference in its entirety.

### TECHNICAL FIELD

Embodiments of the present disclosure relates to computer application technology, particularly to a method for scheduling picking robots, an electronic device and a storage media.

### BACKGROUND

With the networking and intelligentization of the fields of smart manufacturing and warehouse logistics, it has become increasingly common for picking robots to replace humans in performing picking tasks. When there are numerous picking tasks, a single picking robot often needs to execute multiple picking tasks.

In the related art, picking tasks to be executed are typically assigned to picking robots evenly based on the task generation time and the number of tasks received by the picking robots. Since a picking robot must complete the entire process of the previous task before executing a new one, this indiscriminate allocation method for picking tasks makes it difficult to determine the execution status of each picking task. This can lead to unstable response efficiency for picking tasks, potentially leading to situations where some tasks exceed their execution time limits, some picking robots remain idle, while other picking robots face a backlog of tasks, thus affecting the overall picking efficiency.

### SUMMARY

The present disclosure provides a method and apparatus for scheduling picking robots, an electronic device, a storage medium and a program product to improve the efficiency of robots in carrying out picking tasks.

In a first aspect, embodiments of the present disclosure provide a method for scheduling picking robots. The method includes: sorting, in response to receiving multiple picking tasks, the multiple picking tasks based on task association information corresponding to the picking tasks to obtain a task sorting result, the task association information including at least one of total quantity of items of items to be picked corresponding to the picking tasks, packing information, or category information; and scheduling a picking robot to execute the picking tasks according to a working stage of the picking robot and the task sorting result, the working stage including at least one of a picking stage, a packing stage, a replenishment stage, an idle stage, or a maintenance stage.

In a second aspect, embodiments of the present disclosure further provide an apparatus for scheduling picking robots. The apparatus includes: a sorting module configured to, sort, in response to receiving multiple picking tasks, the multiple picking tasks based on task association information corresponding to the picking tasks to obtain a task sorting result, the task association information including at least one of total quantity of items of items to be picked corresponding to the picking tasks, packing information, or category information; and a task execution module configured to schedule a picking robot to execute the picking tasks according to a working stage of the picking robot and the task sorting result, the working stage including at least one of a picking stage, a packing stage, a replenishment stage, an idle stage, or a maintenance stage.

In a third aspect, embodiments of the present disclosure further provide an electronic device, the electronic device includes: one or more processors; and a storage apparatus, storing one or more programs thereon, wherein the one or more programs, when executed by the one or more processors, cause the one or more processors to implement the method for scheduling picking robots in any of the embodiments of the present disclosure.

In a fourth aspect, embodiments of the present disclosure also provide a computer-readable medium having stored thereon computer-executable instructions, wherein when the computer-executable instructions are executed by a computer processor, the method for scheduling picking robots in any of the embodiments of the present disclosure.

In a fifth aspect, embodiments of the present disclosure also provide a computer program product, including a computer program, wherein the computer program, when executed by a processor, implements the method for scheduling picking robots in any of the embodiments of the present disclosure.

According to the technical scheme of this embodiment, in response to receiving multiple picking tasks, the multiple picking tasks are sorted based on task association information corresponding to the picking tasks to obtain a task sorting result, resulting in refined ordering of the multiple picking tasks. Since the task association information includes at least one of the total quantity of items to be picked, packing information, or category information, the sorting of the picking tasks incorporates relevant information about the items to be picked, making the execution order of the picking tasks in the task sorting result more aligned with the actual execution needs. Further, the picking robot is scheduled to execute the picking tasks according to the working stage of the picking robot and the task sorting result, achieving rational scheduling of the picking robots. As the working stage includes at least one of a picking stage, a packing stage, a replenishment stage, an idle stage, or a maintenance stage, a more detailed division of working stages for the picking robots can be made according to the picking process, supporting finer-grained scheduling. This addresses the technical issue of imbalanced scheduling of picking robots caused by averaging the distribution of picking tasks based on quantity in the related art, optimizing the scheduling approach and effectively enhancing the efficiency of the picking robots in executing picking tasks.

### BRIEF DESCRIPTION OF DRAWINGS

With reference to the accompanying drawings and the following detailed description, the above and other features, advantages and aspects of embodiments of the present disclosure will become more apparent. Throughout the drawings, the same or similar reference numerals indicate the same or similar elements. It should be understood that the drawings are schematic, and elements are not necessarily drawn to scale.

FIG. 1 is a schematic flowchart of a method for scheduling picking robots according to an embodiment of the present disclosure;

FIG. 2 is a schematic flowchart of another method for scheduling picking robots according to an embodiment of the present disclosure;

FIG. 3 is a schematic flowchart of yet another method for scheduling picking robots according to an embodiment of the present disclosure;

FIG. 4 is a schematic diagram of an apparatus for scheduling picking robots according to an embodiment of the present disclosure; and

FIG. 5 is a schematic diagram of an electronic device according to an embodiment of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for understanding the present disclosure more thoroughly and completely. It should be understood that the drawings and embodiments of the present disclosure are only for exemplary purposes, and are not intended to limit the protection scope of the present disclosure.

It should be understood that various steps recorded in the implementation modes of the method of the present disclosure may be performed according to different orders and/or performed in parallel. In addition, the implementation modes of the method may include additional steps and/or omit the illustrated steps. The scope of the present disclosure is not limited in this aspect.

The term “including” and variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that the concepts such as “first”, “second”, etc. mentioned in the present disclosure are only used to distinguish different devices, modules or units, and are not used to limit the order of functions performed by these devices, modules or units or interdependence relationship.

It should be noted that the modifiers of “a” and “a plurality of” mentioned in the present disclosure are illustrative rather than restrictive, and those skilled in the art should understand that unless the context clearly indicates otherwise, they should be understood as “one or more”.

The names of messages or information exchanged between multiple devices in the embodiments of the present disclosure are only for illustrative purposes, and are not intended to limit the scope of these messages or information.

FIG. 1 is a schematic flowchart of a method for scheduling picking robots provided by an embodiment of the present disclosure. The embodiment of the present disclosure is applicable to situations where multiple picking tasks are assigned to multiple picking robots. The method can be implemented by an apparatus for scheduling picking robots. The apparatus for scheduling picking robots can be realized by software and/or hardware, or alternatively, by an electronic device, which can be a mobile terminal, a PC terminal or a server.

As shown in FIG. 1, the method for scheduling picking robots provided by this embodiment may include the following steps.

S110, sorting, in response to receiving multiple picking tasks, the multiple picking tasks based on task association information corresponding to the picking tasks to obtain a task sorting result.

The method for scheduling picking robots provided by the present disclosure is applied in smart warehouse systems. The present smart warehouse system mainly consists of a warehouse management system (WMS), multiple sorting stations, multiple picking robots, and multiple movable shelves. The multiple sorting stations and the WMS may be located at the edges within the warehouse. The multiple movable shelves may be arranged systematically in the center of the warehouse, forming an array of shelves in multiple rows and columns. The picking robot includes at least one container to carry the items to be picked corresponding to the picking tasks. The picking robots move within the warehouse to pick the items corresponding to the picking tasks. Multiple navigation markers may be set on a warehouse floor for the navigation and positioning of the picking robots, and the picking robots can use the navigation markers for positioning and move to the corresponding shelves for picking. The entire system is managed by the WMS which processes incoming orders, generates picking tasks, and assigns the picking tasks to the picking robots.

Here, the task association information may be understood as information related to the picking tasks, serving to determine the sequence in which the picking tasks are executed. The task association information includes at least one of the total quantity of items to be picked corresponding to the picking tasks, packing information, or category information. The total quantity of items to be picked may refer to the total number of items included in the picking task. A larger total quantity may increase the likelihood of being prioritized for assignment to the picking robot.

The packing information may be understood as information related to the operation of packaging the items to be picked in the picking task into packages. For example, in response to the picking task including one item to be picked, it will certainly result in one package. In response to the picking task including multiple items, it may generate one or more packages. When packing multiple items to be picked, various methods of packaging may be used. For instance, the multiple items to be picked may be split into several packages based on factors such as item category, item volume, item weight, and warehouse location. For example, the packing information includes at least the number of packages being packed. Additionally, the packing information may include at least one of the package volume, packing time, or packing complexity. The packing complexity may be determined based on at least one of the following factors: the number of packing operators, the space occupied during packing, or the method of packing. Alternatively, the more packages there are, the higher the ranking, and the greater the probability of being prioritized for assignment to the picking robots.

The category information may be understood as the information presented after classifying the items to be picked. Specifically, the category information may include the number of categories derived from the classification of the items to be picked based on corresponding stock keeping units (SKU). A higher number of categories may increase the probability of being prioritized for assignment to the picking robot. For example, the corresponding number of categories for the items to be picked may be determined based on the item information related to the picking task. The item information may include at least one of the item identifier or quantity reference representation for each item to be picked. The item identifier may be used to distinguish between different categories of items, so the number of categories is determined based on the item identifier for each item to be picked corresponding to the picking task, meaning that the number of categories corresponds to the number of item identifiers. The quantity reference representation describes the way to express the number of items to be picked, so the number of categories is determined based on the quantity reference representation for each item to be picked corresponding to the picking task, for instance, if there are 5 units of item A, 2 units of item B, and 3 units of item C, the number of categories is determined to be 3.

In one alternative implementation of the embodiment of the present disclosure, the number of categories corresponding to the items to be picked may be determined based on the display method of the item information for the items to be picked related to the picking task. Specifically, display areas corresponding to the item information for the items to be picked of the same SKU corresponding to the picking task may be identified, and then the number of the display areas may be used to determine the number of categories for the items to be picked. In one example, the item information for the items to be picked corresponding to the picking task is displayed in rows, while the item information for items of the same SKU is displayed in a single row. In this case, the number of display rows for the items to be picked may be counted to determine the number of categories.

Specifically, the total quantity of items to be picked corresponding to each picking task, the packing information, and the category information are acquired; sorting indicators for each picking task are determined based on at least one of the total quantity of items to be picked corresponding to each picking task, the packing information, or the category information; and the multiple picking tasks are sorted according to the sorting indicators to obtain the task sorting result.

Here, the sorting indicators may be attribute values used to determine the order of allocation for the picking tasks. For example, the sorting indicators may be scoring values for the picking tasks or levels of allocation priority. The higher the scoring values or allocation priority, the earlier the task ranks, meaning that the corresponding picking task is prioritized for assignment to picking robots, appearing closer to the top of the task sorting result.

For instance, a first correlation between different total quantities of items and the sorting indicators, a second correlation between the packing information and the sorting indicators, and a third correlation between the category information and the sorting indicators may be predefined. These correlations may be represented using but not limited to piecewise functions.

The specific method for sorting the multiple picking tasks according to the sorting indicators to obtain the task sorting result may include the following steps:
A. in response to the task association information including the total quantity of items to be picked corresponding to each picking task, determining a first sorting indicator for each picking task based on the total quantity of items to be picked corresponding to each picking task and the first correlation;
B. in response to the task association information including the packing information of items to be picked corresponding to each picking task, determining a second sorting indicator for each picking task based on the packing information of items to be picked corresponding to each picking task and the second correlation;
C. in response to the task association information including the category information of items to be picked corresponding to each picking task, determining a third sorting indicator for each picking task based on the category information of items to be picked corresponding to each picking task and the third correlation; and
D. acquiring at least one of a first candidate sorting indicator, a second candidate sorting indicator, or a third candidate sorting indicator for the picking task, using at least one of the candidate sorting indicators to determine a final sorting indicator, and then sorting the multiple picking tasks based on the final sorting indicator to obtain the task sorting result.

Specifically, in response to the final sorting indicator including at least two candidate sorting indicators, the weighted average of the at least two candidate sorting indicators will be used as the final sorting indicator, and then the multiple picking tasks are sorted based on the final sorting indicator to obtain the task sorting result.

As another alternative but non-limiting implementation, sorting the multiple picking tasks based on task association information corresponding to the picking tasks includes steps A1-A2.

Step A1, determining a first ratio based on the total quantity of items corresponding to the picking tasks and the number of packages, and determining a second ratio based on the total quantity of items corresponding to the picking tasks and the number of categories.

Here, the first ratio and the second ratio may be understood as indicators of the significance of the picking tasks. Specifically, a first correspondence between the first ratio and the sorting indicator and a second correspondence between the second ratio and the sorting indicator are established. The correspondence indicates the range within which the first ratio or the second ratio corresponds to a sorting indicator, which may be represented using but not limited to piecewise functions.

Step A2, sorting the multiple picking tasks according to the total quantity of items corresponding to the picking tasks, the number of packages, the first ratio, and the second ratio.

Specifically, the total quantity of items corresponding to the picking tasks, the number of packages, the first ratio, and the second ratio are acquired; a fourth sorting indicator is determined based on the total quantity of items corresponding to the picking tasks and the first correlation, a fifth sorting indicator is determined based on the number of packages corresponding to the picking tasks and the second correlation, a sixth sorting indicator is determined based on the first ratio corresponding to the picking tasks and the first correspondence, and a seventh sorting indicator is determined based on the second ratio corresponding to the picking tasks and the second correspondence; and then, the final sorting indicator for the picking task is determined based on the fourth sorting indicator, the fifth sorting indicator, the sixth sorting indicator, and the seventh sorting indicator, allowing for the sorting of the multiple picking tasks according to the final sorting indicator to obtain the task sorting result.

Further, determining the final sorting indicator for the picking task based on the fourth sorting indicator, the fifth sorting indicator, the sixth sorting indicator, and the seventh sorting indicator may include the following steps: determining target weights corresponding to the fourth sorting indicator, the fifth sorting indicator, the sixth sorting indicator, and the seventh sorting indicator respectively; and then, determining the final sorting indicator for the picking task based on the fourth sorting indicator, the fifth sorting indicator, the sixth sorting indicator, and the seventh sorting indicator and their corresponding target weights, allowing for the sorting of the multiple picking tasks according to the final sorting indicator to obtain the task sorting result. It should be noted that the target weights corresponding to the fourth sorting indicator, the fifth sorting indicator, the sixth sorting indicator, and the seventh sorting indicator may be the same or different.

According to the technical scheme of this embodiment, by determining a first ratio based on the total quantity of items corresponding to the picking tasks and the number of packages, and determining a second ratio based on the total quantity of items corresponding to the picking tasks and the number of categories, this allows for a further breakdown of the factors influencing the sorting of the picking tasks. Subsequently, the multiple picking tasks are sorted based on the total quantity of items corresponding to the picking tasks, the number of packages, the first ratio, and the second ratio to obtain the task sorting result. By combining the total quantity of items corresponding to the picking tasks, the number of packages, the first ratio, and the second ratio, the determination of the task sorting result becomes more accurate and refined, achieving a reasonable ordering of the allocation sequence for each picking task. This ensures that each picking task can be assigned to the picking robots more rationally, thereby improving the picking task execution efficiency.

S120, scheduling the picking robot to execute the picking tasks according to the working stage of the picking robot and the task sorting result.

Here, the working stage includes at least one of a picking stage, a packing stage, a replenishment stage, an idle stage, or a maintenance stage. The picking stage refers to the phase in which the picking robot retrieves items from the shelves. The packing stage occurs when the picking robot transports the goods to a designated packing location and unloads the cargo box it is carrying. The replenishment stage is when the picking robot arrives at a specified location to load containers capable of holding goods. The idle stage refers to the phase where the picking robot waits for assigned picking tasks. The maintenance stage includes charging the picking robot and performing fault repairs.

Correspondingly, in response to the maintenance stage involving charging the picking robot, it may be set that when the battery level of the picking robot in the maintenance stage reaches a preset value, the picking robot can transition to the idle stage to assist in executing the current picking task. The determination of when the picking robot can transition from the maintenance stage to the idle stage can be realized as follows: the current number of picking tasks is assessed; in response to the current number of picking tasks reaching a preset task quantity, it indicates that there are many goods in the warehouse and more picking robots are needed to assist in executing tasks; at this point, picking robots in the maintenance stage with battery levels at the preset value can be transitioned to the idle stage to help fulfill picking tasks, thereby achieving more efficient and rational task allocation.

Specifically, when the picking robot is in the picking stage, it indicates that the robot is currently executing a picking task, and therefore it is not allowed to be reassigned another picking task. For the packing stage, the replenishment stage, and the idle stage, picking robots in the idle stage are given the highest priority for assignment to the picking tasks that are ranked at the top of the sorting result, followed by those in the replenishment stage and then the packing stage. This approach allows picking robots to avoid completing all the necessary working stages of a picking task before receiving new picking assignments, significantly reducing the time it takes for picking tasks to be allocated.

As another alternative but non-limiting implementation, before scheduling the picking robot to execute the picking tasks according to the working stage of the picking robot and the task sorting result, the method further includes the step of determining the working stage of the picking robot, specifically including: acquiring the location information of the picking robot in a warehouse, and determining the working stage of the picking robot according to a relative positional relationship between the location information and working areas, the warehouse including at least two working areas, and the working areas including at least one of a waiting area, a replenishment area, a packing area, a picking area, or a maintenance area.

According to the technical scheme of this embodiment, the working stage of the picking robot is accurately determined based on the relative positional relationship between the location information of the picking robot in the warehouse and the working areas. This facilitates the accurate assignment of picking tasks to one of the multiple picking robots, ensuring that the tasks allocated to the robots are more reasonable.

According to the technical scheme of this embodiment, in response to receiving multiple picking tasks, the multiple picking tasks are sorted based on task association information corresponding to the picking tasks to obtain a task sorting result, resulting in refined ordering of the multiple picking tasks. Since the task association information includes at least one of the total quantity of items to be picked, packing information, or category information, the sorting of the picking tasks incorporates relevant information about the items to be picked, making the execution order of the picking tasks in the task sorting result more aligned with the actual execution needs. Further, the picking robot is scheduled to execute the picking tasks according to the working stage of the picking robot and the task sorting result, achieving rational scheduling of the picking robots. As the working stage includes at least one of a picking stage, a packing stage, a replenishment stage, an idle stage, or a maintenance stage, a more detailed division of working stages for the picking robots can be made according to the picking process, supporting finer-grained scheduling. This addresses the technical issue of imbalanced scheduling of picking robots caused by averaging the distribution of picking tasks based on quantity in the related art, optimizing the scheduling approach and effectively enhancing the efficiency of the picking robots in executing picking tasks.

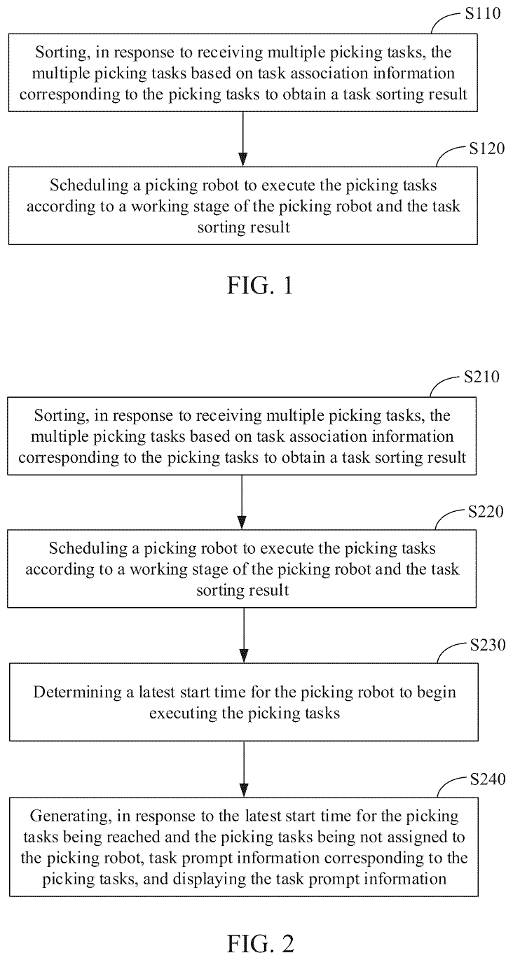

FIG. 2 is a schematic flowchart of another method for scheduling picking robots according to an embodiment of the present disclosure. Based on the previous embodiments, the technical scheme of this embodiment adds the technical feature of transferring urgent picking tasks to manual processing after sorting the multiple picking tasks according to the task association information corresponding to the picking tasks to obtain the task sorting result, ensuring that the picking tasks are completed on time. Detailed implementation can be found in the description of this embodiment. The same or similar technical features as those in the previous embodiments are not repeated here.

As shown in FIG. 2, the method for scheduling picking robots provided by this embodiment may include the following steps.

S210, sorting, in response to receiving multiple picking tasks, the multiple picking tasks based on task association information corresponding to the picking tasks to obtain a task sorting result.

S220, scheduling the picking robot to execute the picking tasks according to the working stage of the picking robot and the task sorting result.

S230, determining a latest start time for the picking robot to begin executing the picking tasks.

The latest start time may be understood as the latest time to begin executing the picking tasks. For example, the latest start time may refer to the deadline for assigning the items corresponding to the picking tasks to the picking robot. Specifically, the latest start time may be determined based on the actual picking situation. The latest start time is used to ascertain whether the picking task can still be executed by a picking robot, that is, in response to the picking task not reaching the latest start time and being not assigned to a picking robot, it indicates that the picking task can still wait to be allocated to a picking robot for execution.

In this embodiment of the present disclosure, the task sorting result of the picking tasks may be further updated based on a time difference between the current time and the latest start time of the picking tasks. For example, the closer the picking task is to the latest start time, the higher its priority in the sorting result, meaning it will be assigned to the picking robots for execution sooner.

As another alternative but non-limiting implementation, the latest start time for the picking robot to begin executing the picking tasks may be determined as follows: identifying a latest completion time for the picking tasks and a picking execution time of the picking robot, and determining the latest start time for the picking robot to begin executing the picking tasks based on the latest completion time and the picking execution time.

The latest completion time may be understood as the latest time to complete the picking tasks. For example, the latest completion time may refer to the time required to finish picking the items to be picked and transport them to a target location (packing location). Alternatively, the latest completion time may be determined based on a task generation time of the picking task and a task response duration. The task response duration may be set according to actual needs and is not specifically limited here; for instance, it may be 2 hours, 12 hours, 24 hours, or 48 hours, etc.

For example, in response to the latest completion time for the picking tasks being set at 5 PM and the picking execution time for the picking robot is 40 minutes, to ensure that the picking tasks can be smoothly assigned and to prevent delays due to tight picking execution schedules that prevent the use of the picking robot, a preset buffer time, such as 20 minutes, is added. Thus, the final latest start time for the picking robot to begin executing the picking tasks is 4 PM.

S240, generating, in response to the latest start time for the picking tasks being reached and the picking tasks being not assigned to the picking robot, task prompt information corresponding to the picking tasks, and displaying the task prompt information.

Here, the task prompt information is used to inform a user that the picking tasks need to be manually picked.

In this embodiment of the present disclosure, the task prompt information corresponding to the picking tasks is generated, which may specifically include: acquiring target information of the picking tasks and preset prompt text, and generating the task prompt information corresponding to the picking tasks based on the target information and the preset prompt text. Here, the target information may be understood as a task identifier for the picking task. The preset prompt text may be understood as a prompt text template to be displayed. The format of the task prompt information may take various forms, such as at least one of text, images, animations, videos, or audios. Alternatively, displaying the task prompt information may include: displaying the task prompt information on a display interface of a target terminal, or playing the task prompt information through playback devices, etc.

Specifically, in response to the latest start time for the picking tasks being reached and the picking tasks being not assigned to the picking robot, it indicates that if the picking tasks continue to wait for allocation to the picking robot, there may be a risk of task response timeout, making it impossible to complete the tasks on time. In this case, the picking tasks need to be executed immediately. At this point, the task prompt information corresponding to the picking tasks can be generated to notify the user that the picking tasks need to be manually picked to expedite the execution.

According to the technical scheme of this embodiment, the latest start time for the picking robot to begin executing the picking tasks is determined, so as to assess whether the time at which the picking robot starts executing the picking tasks has reached the latest start time. This allows for accurate determination of whether to continue waiting for the picking robot to perform the picking tasks. In response to the latest start time for the picking tasks being reached and the picking tasks being not assigned to the picking robot, it indicates that the picking tasks are no longer suitable for execution by the picking robot. Consequently, the task prompt information corresponding to the picking tasks is generated to prevent the picking tasks from remaining unexecuted for an extended period, which may affect the responsiveness to picking tasks, thereby guaranteeing the successful execution of the picking tasks.

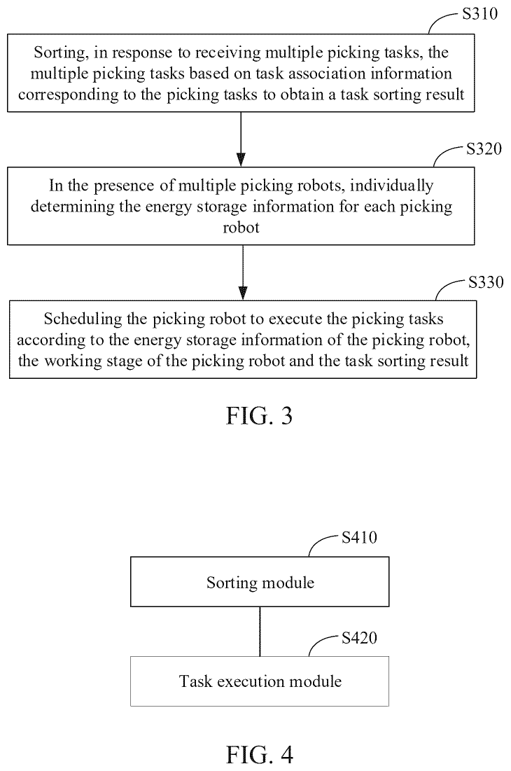

FIG. 3 is a schematic flowchart of yet another method for scheduling picking robots according to an embodiment of the present disclosure. Based on the previous embodiments, the technical scheme of this embodiment further refines the method of scheduling the picking robot to execute the picking tasks according to the working stage of the picking robot and the task sorting result. Detailed implementation can be found in the description of this embodiment. The same or similar technical features as those in the previous embodiments are not repeated here.

As shown in FIG. 3, the method for scheduling picking robots provided by this embodiment may include the following steps.

S310, sorting, in response to receiving multiple picking tasks, the multiple picking tasks based on task association information corresponding to the picking tasks to obtain a task sorting result.

Here, the task association information includes at least one of the total quantity of items to be picked corresponding to the picking tasks, packing information, or category information.

S320, in the presence of multiple picking robots, individually determining the energy storage information for each picking robot.

Here, the energy storage information includes battery information the information of containers being carried.

Specifically, determining the energy storage information for each picking robot is aimed at optimally allocating picking tasks to the most suitable picking robots, meaning that picking robots with higher battery levels and greater capacity can take on the picking tasks that are ranked higher in the task sorting result.

S330, scheduling the picking robot to execute the picking tasks according to the energy storage information of the picking robot, the working stage of the picking robot and the task sorting result.

Specifically, the energy storage information and current working stages of the picking robots are acquired; based on the task sorting result, the urgency of each picking task is determined, and high-urgency picking tasks are assigned first to picking robots that are in the idle stage and have higher energy storage levels; subsequently, picking tasks are assigned in succession to picking robots in the replenishment stage and then in the packing stage, that are ranked higher in the preset energy storage ranking, which arranges the energy storage information from high to low.

As an alternative technical scheme of this embodiment, candidate robots may be first identified from the multiple picking robots based on the working stages of the picking robots; then, a target robot is identified from the candidate robots based on the energy storage information of the picking robots; and subsequently, the picking tasks are assigned to the target robot.

As another alternative technical scheme of this embodiment, a first scheduling indicator for the picking robot may be determined based on the energy storage information of the picking robot, a second scheduling indicator for the picking robot may be determined according to the working stage of the picking robot, and the picking robot is then scheduled to execute the picking tasks based on the first scheduling indicator and the second scheduling indicator.

Further, scheduling the picking robot to execute the picking tasks based on the first scheduling indicator and the second scheduling indicator may involve comparing the first scheduling indicators and the second scheduling indicators of multiple picking robots and then scheduling the picking robots to execute the picking tasks according to comparison results. For example, in response to the first scheduling indicators of different picking robots being at the same level, the picking robots are scheduled to execute the picking tasks based on the second scheduling indicators. In response to both the first scheduling indicators and the second scheduling indicators of different picking robots being at the same level, the picking robots may be scheduled randomly to execute the picking tasks, or the picking robots may be scheduled to execute the picking tasks based on the location information of the picking robots and/or the volume of tasks already executed.

Alternatively, scheduling the picking robot to execute the picking tasks based on the first scheduling indicator and the second scheduling indicator includes: determining a target scheduling indicator for the picking robot based on the first scheduling indicator and the second scheduling indicator, and then scheduling the picking robot to execute the picking tasks according to the target scheduling indicator. There are various methods to determine the target scheduling indicator for the picking robot based on the first scheduling indicator and the second scheduling indicator; for example, the target scheduling indicator for the picking robot may be obtained by weighted summation of the first scheduling indicator and the second scheduling indicator.

According to the technical scheme of this embodiment, in response to receiving multiple picking tasks, the multiple picking tasks are sorted based on task association information corresponding to the picking tasks to obtain a task sorting result; further, in the presence of multiple picking robots, the energy storage information for each picking robot is individually determined. This comprehensive consideration of factors affecting the performance of picking robots in executing picking tasks provides additional assurance for the rapid and smooth execution of picking tasks. Consequently, this facilitates the reasonable and efficient allocation of picking tasks to each picking robot, which may be in different working stages, according to the energy storage information of the picking robot, the working stage of the picking robot and the task sorting result. This approach avoids efficiency reduction caused by a robot receiving the next picking task only after completing all working stages of the previous task, thereby enhancing the efficiency of robots in executing picking tasks.

FIG. 4 is a schematic diagram of an apparatus for scheduling picking robots according to an embodiment of the present disclosure. The embodiment of the present disclosure is applicable to the scenario of scheduling picking robots. The apparatus for scheduling picking robots can be realized by software and/or hardware, or alternatively, by an electronic device, which can be a mobile terminal, a PC terminal or a server.

As shown in FIG. 4, the apparatus for scheduling picking robots may include a sorting module 410 and a task execution module 420. Here, the sorting module 410 is configured to, sort, in response to receiving multiple picking tasks, the multiple picking tasks based on task association information corresponding to the picking tasks to obtain a task sorting result, the task association information including at least one of the total quantity of items to be picked corresponding to the picking tasks, packing information, or category information; and the task execution module 420 is configured to schedule the picking robot to execute the picking tasks according to a working stage of the picking robot and the task sorting result, the working stage including at least one of a picking stage, a packing stage, a replenishment stage, an idle stage, or a maintenance stage.

According to the technical scheme of this embodiment, in response to receiving multiple picking tasks, the multiple picking tasks are sorted by the sorting module 410 based on task association information corresponding to the picking tasks to obtain a task sorting result, resulting in refined ordering of the multiple picking tasks. Since the task association information includes at least one of the total quantity of items to be picked corresponding to the picking task, packing information, or category information, the sorting of the picking tasks incorporates relevant information about the items to be picked, making the execution order of the picking tasks in the task sorting result more aligned with the actual execution needs. Further, the picking robot is scheduled by the task execution module 420 to execute the picking tasks according to the working stage of the picking robot and the task sorting result, achieving rational scheduling of the picking robots. Given that the working stage includes at least one of a picking stage, a packing stage, a replenishment stage, an idle stage, or a maintenance stage, a more detailed division of working stages for the picking robots can be made according to the picking process, supporting finer-grained scheduling. This addresses the technical issue of imbalanced scheduling of picking robots caused by averaging the distribution of picking tasks based on quantity in the related art, optimizing the scheduling approach and effectively enhancing the efficiency of the picking robots in executing picking tasks.

On the basis of the above alternative technical schemes, alternatively, the packing information includes at least the number of packages being packed, and the category information includes the number of categories derived from the classification of the items to be picked based on corresponding SKU.

On the basis of the above alternative technical schemes, alternatively, the sorting module includes a ratio determining unit and a task sorting unit. Here, the ratio determining unit is configured to determine a first ratio based on the total quantity of items corresponding to the picking tasks and the number of packages, and determine a second ratio based on the total quantity of items corresponding to the picking tasks and the number of categories; and the task sorting unit is configured to sort the multiple picking tasks according to the total quantity of items corresponding to the picking tasks, the number of packages, the first ratio, and the second ratio.

On the basis of the above alternative technical schemes, alternatively, the sorting module further includes a time determining unit and a task information prompting unit. Here, the time determining unit is configured to determine a latest start time for the picking robot to begin executing the picking tasks; and the task information prompting unit is configured to, in response to the latest start time for the picking tasks being reached and the picking tasks being not assigned to the picking robot, generate task prompt information corresponding to the picking tasks, and display the task prompt information, the task prompt information being used to inform a user that the picking tasks need to be manually picked.

On the basis of the above alternative technical schemes, alternatively, the time determining unit is specifically configured to determine a latest completion time for the picking tasks and a picking execution time for the picking robot; and determine the latest start time for the picking robot to begin executing the picking tasks based on the latest completion time and the picking execution time.

On the basis of the above alternative technical schemes, alternatively, the task execution module includes an energy storage information acquisition unit and a robot scheduling unit. Here, the energy storage information acquisition unit is configured to, in the presence of multiple picking robots, individually determine the energy storage information for each picking robot, the energy storage information including battery information and/or the information of containers being carried; and the robot scheduling unit is configured to schedule the picking robot to execute the picking tasks according to the energy storage information of the picking robot, the working stage of the picking robot and the task sorting result.

On the basis of the above alternative technical schemes, alternatively, the task execution module further includes a robot location determining unit and a working stage determining unit. Here, the robot location determining unit is configured to acquire the location information of the picking robot in a warehouse, the warehouse including at least two working areas, and the working areas including at least one of a waiting area, a replenishment area, a packing area, a picking area, or a maintenance area; and the working stage determining unit is configured to determine the working stage of the picking robot according to a relative positional

The apparatus for scheduling picking robots provided by the embodiments of the present disclosure can perform the method for scheduling picking robots provided by any embodiment of the present disclosure, and has corresponding functional modules for executing the method and beneficial effects.

It should be noted that the plurality of units and modules included in the apparatus are categorized based on functional logic, but this classification is not restrictive, as long as corresponding functions can be realized. In addition, the names of multiple functional units are only for the convenience of distinguishing each other, and are not used to limit the protection scope of the embodiments of the present disclosure.

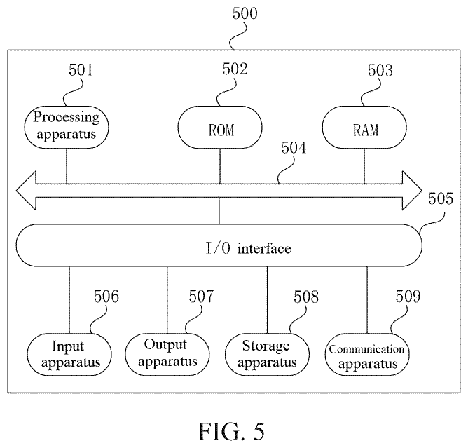

FIG. 5 is a structural diagram of an electronic device according to embodiments of the present disclosure. Referring to FIG. 5, it is a structural diagram of an electronic device (for example, the terminal device or server in FIG. 5) 500 suitable for implementing the embodiments of the present disclosure. The terminal device in the embodiments of the present disclosure may include but not limited to mobile terminals such as mobile phones, notebook computers, digital broadcast receivers, personal digital assistants (PDA), portable android devices (PAD), portable multimedia players (PMP), and vehicle-mounted terminals (such as vehicle-mounted navigation terminals), and fixed terminals such as digital TV and desktop computers. The electronic device shown in FIG. 5 is only an example, and should not impose any limitations on the functionality and scope of use of the embodiments of the present disclosure.

As shown in FIG. 5, the electronic device 500 may include a processing apparatus (such as a central processing unit, and a graphics processor) 501, it may execute various appropriate actions and processes according to a program stored in a read-only memory (ROM) 502 or a program loaded from a storage apparatus 508 to a random access memory (RAM) 503. In RAM 503, various programs and data required for operations of the electronic device 500 are also stored. The processing apparatus 501, ROM 502, and RAM 403 are connected to each other by a bus 504. An input/output (I/O) interface 505 is also connected to the bus 504.

The following apparatuses may be connected to the I/O interface 505: an input apparatus 506 such as a touch screen, a touchpad, a keyboard, a mouse, a camera, a microphone, an accelerometer, and a gyroscope; an output apparatus 507 such as a liquid crystal display (LCD), a loudspeaker, and a vibrator; a storage apparatus 508 such as a magnetic tape, and a hard disk drive; and a communication apparatus 509. The communication apparatus 509 may allow the electronic device 500 to wireless-communicate or wire-communicate with other devices so as to exchange data. Although FIG. 5 shows the electronic device 500 with various apparatuses, it should be understood that it is not required to implement or possess all the apparatuses shown. Alternatively, it may implement or possess the more or less apparatuses.

In particular, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication apparatus 509, or installed from the storage apparatus 508, or installed from ROM 502. When the computer program is executed by the processing apparatus 501, the above functions defined in the method in the embodiments of the present disclosure are executed.

The names of messages or information exchanged between multiple devices in the embodiments of the present disclosure are only for illustrative purposes, and are not intended to limit the scope of these messages or information.

The electronic device provided in this embodiment and the method for scheduling picking robots provided in the above embodiment belong to the same inventive concept. Technical details not described in this embodiment can be found in the above embodiment, and this embodiment has the same beneficial effects as the above embodiment.

Embodiments of the present disclosure provide a computer storage medium, on which a computer program is stored, which, when executed by a processor, implements the method for scheduling picking robots provided in the above embodiment.

The above computer-readable medium in the present disclosure may be a computer-readable signal medium, a computer-readable storage medium, or any combinations of the two. The computer-readable storage medium may be, for example, but not limited to, a system, an apparatus or a device of electricity, magnetism, light, electromagnetism, infrared, or semiconductor, or any combinations of the above. More specific examples of the computer-readable storage medium may include but not be limited to: an electric connector with one or more wires, a portable computer magnetic disk, a hard disk drive, a random access memory (RAM), a read-only memory (ROM), an erasable programmable read-only memory (EPROM or flash memory), an optical fiber, a portable compact disk read-only memory (CD-ROM), an optical storage device, a magnetic storage device or any suitable combinations of the above. In the present disclosure, the computer-readable storage medium may be any visible medium that contains or stores a program, and the program may be used by an instruction executive system, apparatus or device or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, apparatus or device or in combination with it. The program code contained on the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The above-described computer-readable medium may be included in the above-described electronic device, or may also exist alone without being assembled into the electronic device.

The above-described computer-readable medium carries one or more programs that, when executed by the electronic device, cause the electronic device to: sort, in response to receiving multiple picking tasks, the multiple picking tasks based on task association information corresponding to the picking tasks to obtain a task sorting result, the task association information including at least one of the total quantity of items to be picked corresponding to the picking tasks, packing information, or category information; and schedule the picking robot to execute the picking tasks according to a working stage of the picking robot and the task sorting result, the working stage including at least one of a picking stage, a packing stage, a replenishment stage, an idle stage, or a maintenance stage.

The computer program code for executing the operation of the present disclosure may be written in one or more programming languages or combinations thereof, the above programming language includes but not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, this depends on the function involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The involved units described in the embodiments of the present disclosure may be achieved by a mode of software, or may be achieved by a mode of hardware. Here, the name of the unit does not constitute a limitation for the unit itself in some cases. For example, the sorting module may also be described as “a module that acquires a sorting result of multiple picking tasks”.

The functions described above in this article may be at least partially executed by one or more hardware logic components. For example, non-limiting exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combinations of the above. More specific examples of the machine-readable storage medium may include an electric connector based on one or more wires, a portable computer disk, a hard disk drive, RAM, ROM, EPROM (or a flash memory), an optical fiber, CD-ROM, an optical storage device, a magnetic storage device, or any suitable combinations of the above.

According to one or more embodiments of the present disclosure, [Example 1] provides a method for scheduling picking robots, including: sorting, in response to receiving multiple picking tasks, the multiple picking tasks based on task association information corresponding to the picking tasks to obtain a task sorting result, the task association information including at least one of the total quantity of items to be picked corresponding to the picking tasks, packing information, or category information; and scheduling the picking robot to execute the picking tasks according to a working stage of the picking robot and the task sorting result, the working stage including at least one of a picking stage, a packing stage, a replenishment stage, an idle stage, or a maintenance stage.

According to one or more embodiments of the present disclosure, [Example 2] provides the method of Example 1; alternatively, the packing information includes at least the number of packages being packed, and the category information includes the number of categories derived from the classification of the items to be picked based on corresponding SKU.

According to one or more embodiments of the present disclosure, [Example 3] provides the method of Example 2; alternatively, wherein sorting the multiple picking tasks based on task association information corresponding to the picking tasks includes: determining a first ratio based on the total quantity of items corresponding to the picking tasks and the number of packages, and determining a second ratio based on the total quantity of items corresponding to the picking tasks and the number of categories; and sorting the multiple picking tasks according to the total quantity of items corresponding to the picking tasks, the number of packages, the first ratio, and the second ratio.

According to one or more embodiments of the present disclosure, [Example 4] provides the method of Example 1; alternatively, after sorting the multiple picking tasks based on task association information corresponding to the picking tasks to obtain a task sorting result, further including: determining a latest start time for the picking robot to begin executing the picking tasks; and in response to the latest start time for the picking tasks being reached and the picking tasks being not assigned to the picking robot, generating task prompt information corresponding to the picking tasks, and displaying the task prompt information, the task prompt information being used to inform a user that the picking tasks need to be manually picked.

According to one or more embodiments of the present disclosure, [Example 5] provides the method of Example 4; alternatively, wherein determining a latest start time for the picking robot to begin executing the picking tasks includes: determining a latest completion time for the picking tasks and a picking execution time for the picking robot; and determining the latest start time for the picking robot to begin executing the picking tasks based on the latest completion time and the picking execution time.

According to one or more embodiments of the present disclosure, [Example 6] provides the method of Example 1; alternatively, wherein scheduling the picking robot to execute the picking tasks according to a working stage of the picking robot and the task sorting result includes:
in the presence of multiple picking robots, individually determining energy storage information for each picking robot, the energy storage information including battery information and/or information of containers being carried; and scheduling the picking robot to execute the picking tasks according to the energy storage information of the picking robot, the working stage of the picking robot and the task sorting result.

According to one or more embodiments of the present disclosure, [Example 7] provides the method of Example 1; alternatively, before scheduling the picking robot to execute the picking tasks according to a working stage of the picking robot and the task sorting result, further including:
acquiring location information of the picking robot in a warehouse, the warehouse including at least two working areas, the working areas including at least one of a waiting area, a replenishment area, a packing area, a picking area, or a maintenance area; and determining the working stage of the picking robot according to a relative positional relationship between the location information and the working areas.

According to one or more embodiments of the present disclosure, [Example 8] provides an apparatus for scheduling picking robots, including: a sorting module configured to, sort, in response to receiving multiple picking tasks, the multiple picking tasks based on task association information corresponding to the picking tasks to obtain a task sorting result, the task association information including at least one of total quantity of items of items to be picked corresponding to the picking tasks, packing information, or category information; and a task execution module configured to schedule a picking robot to execute the picking tasks according to a working stage of the picking robot and the task sorting result, the working stage including at least one of a picking stage, a packing stage, a replenishment stage, an idle stage, or a maintenance stage.

The above are only preferred embodiments of the present disclosure and the explanation of the applied technical principles. It should be understood by those skilled in the art that the disclosure scope involved in the present disclosure is not limited to the technical scheme formed by the specific combination of the above technical features, but also covers other technical schemes formed by any combination of the above technical features or their equivalent features without departing from the above disclosure concept, such as a technical scheme formed by mutual replacement of the above-mentioned features and technical features with similar functions disclosed in the present disclosure (but not limited thereto).

Further, although the operations are depicted in a particular order, this should not be understood as requiring that these operations be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological actions, it should be understood that the subject matter defined in the appended claims is not necessarily limited to the specific features or actions described above. On the contrary, the specific features and actions described above are only exemplary forms of implementing the claims.

What is claimed is:

1. A method for scheduling picking robots, comprising:
sorting, in response to receiving multiple picking tasks, the multiple picking tasks based on task association information corresponding to the picking tasks to obtain a task sorting result, the task association information comprising at least one of total quantity of items of items to be picked corresponding to the picking tasks, packing information, or category information; and
scheduling a picking robot to execute the picking tasks according to a working stage of the picking robot and the task sorting result, the working stage comprising at least one of a picking stage, a packing stage, a replenishment stage, an idle stage, or a maintenance stage.

2. The method for scheduling picking robots according to claim 1, wherein the packing information comprises at least a number of packages being packed, and the category information comprises a number of categories obtained based on a classification of stock keeping units (SKU) corresponding to the items to be picked.

3. The method for scheduling picking robots according to claim 2, wherein sorting the multiple picking tasks based on task association information corresponding to the picking tasks comprises:
determining a first ratio based on the total quantity of items and the number of packages, and determining a second ratio based on the total quantity of items and the number of categories; and
sorting the multiple picking tasks according to the total quantity of items, the number of packages, the first ratio, and the second ratio.

4. The method for scheduling picking robots according to claim 1, after sorting the multiple picking tasks based on task association information corresponding to the picking tasks to obtain a task sorting result, further comprising:
determining a latest start time for the picking robot to begin executing the picking tasks; and
in response to the latest start time for the picking tasks being reached and the picking tasks being not assigned to the picking robot, generating task prompt information corresponding to the picking tasks, and displaying the task prompt information, the task prompt information being used to inform a user that the picking tasks need to be manually picked.

5. The method for scheduling picking robots according to claim 4, wherein determining a latest start time for the picking robot to begin executing the picking tasks comprises:
determining a latest completion time for the picking tasks and a picking execution time for the picking robot; and
determining the latest start time for the picking robot to begin executing the picking tasks based on the latest completion time and the picking execution time.

6. The method for scheduling picking robots according to claim 1, wherein scheduling the picking robot to execute the picking tasks according to a working stage of the picking robot and the task sorting result comprises:
in the presence of multiple picking robots, individually determining energy storage information for each picking robot, the energy storage information comprising at least one of battery information or information of containers being carried; and
scheduling the picking robot to execute the picking tasks according to the energy storage information of the picking robot, the working stage of the picking robot and the task sorting result.

7. The method for scheduling picking robots according to claim 1, before scheduling the picking robot to execute the picking tasks according to a working stage of the picking robot and the task sorting result, further comprising:
acquiring location information of the picking robot in a warehouse, the warehouse comprising at least two working areas, the working areas comprising at least one of a waiting area, a replenishment area, a packing area, a picking area, or a maintenance area; and
determining the working stage of the picking robot according to a relative positional

8. An electronic device, comprising:
one or more processors; and
a memory configured to store one or more programs, wherein
when the one or more programs are executed by the one or more processors, the one or more processors perform an operation for scheduling picking robots, the operation comprising:
sorting, in response to receiving multiple picking tasks, the multiple picking tasks based on task association information corresponding to the picking tasks to obtain a task sorting result, the task association information comprising at least one of total quantity of items of items to be picked corresponding to the picking tasks, packing information, or category information; and
scheduling a picking robot to execute the picking tasks according to a working stage of the picking robot and the task sorting result, the working stage comprising at least one of a picking stage, a packing stage, a replenishment stage, an idle stage, or a maintenance stage.

9. The electronic device according to claim 8, wherein the packing information comprises at least a number of packages being packed, and the category information comprises a number of categories obtained based on a classification of stock keeping units (SKU) corresponding to the items to be picked.

10. The electronic device according to claim 9, wherein sorting the multiple picking tasks based on task association information corresponding to the picking tasks comprises:
determining a first ratio based on the total quantity of items and the number of packages, and determining a second ratio based on the total quantity of items and the number of categories; and
sorting the multiple picking tasks according to the total quantity of items, the number of packages, the first ratio, and the second ratio.

11. The electronic device according to claim 8, after sorting the multiple picking tasks based on task association information corresponding to the picking tasks to obtain a task sorting result, the operation further comprising:
determining a latest start time for the picking robot to begin executing the picking tasks; and
in response to the latest start time for the picking tasks being reached and the picking tasks being not assigned to the picking robot, generating task prompt information corresponding to the picking tasks, and displaying the task prompt information, the task prompt information being used to inform a user that the picking tasks need to be manually picked.

12. The electronic device according to claim 11, wherein determining a latest start time for the picking robot to begin executing the picking tasks comprises:
determining a latest completion time for the picking tasks and a picking execution time for the picking robot; and
determining the latest start time for the picking robot to begin executing the picking tasks based on the latest completion time and the picking execution time.

13. The electronic device according to claim 8, wherein scheduling the picking robot to execute the picking tasks according to a working stage of the picking robot and the task sorting result comprises:
in the presence of multiple picking robots, individually determining energy storage information for each picking robot, the energy storage information comprising battery information or information of containers being carried; and
scheduling the picking robot to execute the picking tasks according to the energy storage information of the picking robot, the working stage of the picking robot and the task sorting result.

14. The electronic device according to claim 8, before scheduling the picking robot to execute the picking tasks according to a working stage of the picking robot and the task sorting result, the operation further comprising:
acquiring location information of the picking robot in a warehouse, the warehouse comprising at least two working areas, the working areas comprising at least one of a waiting area, a replenishment area, a packing area, a picking area, or a maintenance area; and
determining the working stage of the picking robot according to a relative positional

15. A non-transitory storage medium containing computer-executable instructions, wherein the computer-executable instructions, when executed by a computer processor, perform an operation for scheduling picking robots, the operation comprising:
sorting, in response to receiving multiple picking tasks, the multiple picking tasks based on task association information corresponding to the picking tasks to obtain a task sorting result, the task association information comprising at least one of total quantity of items of items to be picked corresponding to the picking tasks, packing information, or category information; and
scheduling a picking robot to execute the picking tasks according to a working stage of the picking robot and the task sorting result, the working stage comprising at least one of a picking stage, a packing stage, a replenishment stage, an idle stage, or a maintenance stage.

16. The storage medium according to claim 15, wherein the packing information comprises at least a number of packages being packed, and the category information comprises a number of categories obtained based on a classification of stock keeping units (SKU) corresponding to the items to be picked.

17. The storage medium according to claim 16, wherein sorting the multiple picking tasks based on task association information corresponding to the picking tasks comprises:
determining a first ratio based on the total quantity of items and the number of packages, and determining a second ratio based on the total quantity of items and the number of categories; and
sorting the multiple picking tasks according to the total quantity of items, the number of packages, the first ratio, and the second ratio.

18. The storage medium according to claim 15, after sorting the multiple picking tasks based on task association information corresponding to the picking tasks to obtain a task sorting result, the operation further comprising:
determining a latest start time for the picking robot to begin executing the picking tasks; and
in response to the latest start time for the picking tasks being reached and the picking tasks being not assigned to the picking robot, generating task prompt information corresponding to the picking tasks, and displaying the task prompt information, the task prompt information being used to inform a user that the picking tasks need to be manually picked.

19. The storage medium according to claim 18, wherein determining a latest start time for the picking robot to begin executing the picking tasks comprises:
determining a latest completion time for the picking tasks and a picking execution time for the picking robot; and
determining the latest start time for the picking robot to begin executing the picking tasks based on the latest completion time and the picking execution time.

20. The storage medium according to claim 15, wherein scheduling the picking robot to execute the picking tasks according to a working stage of the picking robot and the task sorting result comprises:
in the presence of multiple picking robots, individually determining energy storage information for each picking robot, the energy storage information comprising battery information or information of containers being carried; and
scheduling the picking robot to execute the picking tasks according to the energy storage information of the picking robot, the working stage of the picking robot and the task sorting result.
